(19) United States
(12) Patent Application Publication
(10) Pub. No.: US 2011/0314365 A1
(43) Pub. Date: Dec. 22, 2011

(54) DECOMPILING LOOPS IN A SPREADSHEET

(75) Inventors: John Benjamin Messerly, Seattel, WA (US); James J. Hugunin, Mercer Island, WA (US); Jonathon Michael Stall, Bothell, WA (US); Curt Oliver Hagenlocher, Mercer Island, WA (US)

(73) Assignee: Microsoft Corporation, Redmond, WA (US)

(21) Appl. No.: 12/817,456

(22) Filed: Jun. 17, 2010

(51) Int. Cl. G06F 17/00

(52) U.S. Cl. 715/219

(57) ABSTRACT

The present invention extends to methods, systems, and computer program products for decompiling loops in a spreadsheet. Embodiments of the invention detect loops by walking a dependency graph on a spreadsheet. As nodes are encountered, sequences of the same formulas are looked for in a normalized representation of the spreadsheet (e.g., R1C1 notation). When the same formulas are identified, the formulas may represent a loop. The spatial structure of the cells is analyzed to determine which cells are to be stored in arrays and which cells can be loop carried dependencies.

### CROSS-REFERENCE TO RELATED APPLICATIONS

Not Applicable.

### BACKGROUND

### Background and Relevant Art

Computer systems and related technology affect many aspects of society. Indeed, the computer system's ability to process information has transformed the way we live and work. Computer systems now commonly perform a host of tasks (e.g., word processing, scheduling, accounting, etc.) that prior to the advent of the computer system were performed manually. More recently, computer systems have been coupled to one another and to other electronic devices to form both wired and wireless computer networks over which the computer systems and other electronic devices can transfer electronic data. Accordingly, the performance of many computing tasks are distributed across a number of different computer systems and/or a number of different computing environments.

More specifically, spreadsheet programs are used in a wide variety of different environments. In some more specialized environments, spreadsheets are used in technical computing. For example, domain specialists can use spreadsheets to build and run models and benefit from the rapid prototyping that this form offers. However, fundamental limitations of using spreadsheets as a programming language make them difficult reuse and maintain when changes to a model are entered.

For example, spreadsheets are typically capable of expressing computations that would be loops in conventional programming languages. However, these computations are expressed in space instead of time. Thus, “loops” within in a spreadsheet can become very large, are of fixed size, and are not obviously visible on the spreadsheet. These difficulties can make it difficult for a user to recognize and change expressions associated with loops within a spreadsheet.

### BRIEF SUMMARY

The present invention extends to methods, systems, and computer program products for decompiling loops in a spreadsheet. A spreadsheet is pared to identify a plurality of formulas within the spreadsheet. A normalized representation of the plurality of formulas is generated. The normalized representation of the plurality of formulas indicates relative differences between cell positions within the spreadsheet. Dependencies between the plurality of formulas are calculated.

Any circular references between cells of the spreadsheet are calculated based on the calculated dependencies between the plurality of formulas. Cells with detected circular references are marked as being part of an iterative calculation. For one or more of the marked cells, one or more patterns of repetitive formulas are identified from the normalized representation of the plurality of formulas. It is determined that the one or more patterns of repetitive formulas represent at least one loop. Loop input data and loop output data is calculated for the at least one loop from the plurality of formulas.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer architecture that facilitates decompiling loops in a spreadsheet.

FIG. 2 illustrates a flow chart of an example method for decompiling loops in a spreadsheet

FIG. 3 illustrates an example of representing overlapping portions of a spreadsheet within an array.

FIG. 4 illustrates a data view and corresponding formula view for a spreadsheet.

### DETAILED DESCRIPTION

The present invention extends to methods, systems, and computer program products for decompiling loops in a spreadsheet. A spreadsheet is pared to identify a plurality of formulas within the spreadsheet. A normalized representation of the plurality of formulas is generated. The normalized representation of the plurality of formulas indicates relative differences between cell positions within the spreadsheet. Dependencies between the plurality of formulas are calculated.

Any circular references between cells of the spreadsheet are calculated based on the calculated dependencies between the plurality of formulas. Cells with detected circular references are marked as being part of an iterative calculation. For one or more of the marked cells, one or more patterns of repetitive formulas are identified from the normalized representation of the plurality of formulas. It is determined that the one or more patterns of repetitive formulas represent at least one loop. Loop input data and loop output data is calculated for the at least one loop from the plurality of formulas.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the invention detect loops by walking a dependency graph on a spreadsheet. As nodes are encountered, sequences of the same formulas are looked for in a normalized representation of the spreadsheet (e.g., R1C1 notation). When the same formulas are identified, the formulas may represent a loop. The spatial structure of the cells is analyzed to determine which cells are to be stored in arrays and which cells can be loop carried dependencies.

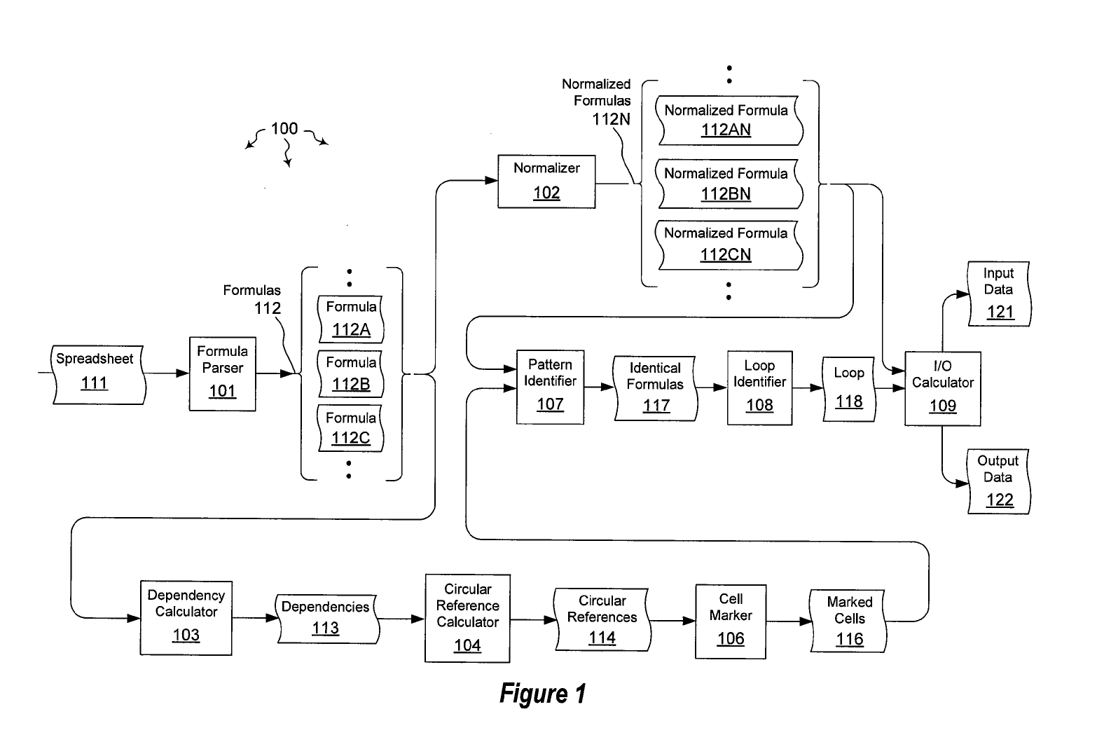

FIG. 1 illustrates an example computer architecture 100 that facilitates decompiling loops in a spreadsheet. Referring to FIG. 1, computer architecture 100 includes formulate parser 101, normalize 102, dependency calculator 103, circular reference calculator 104, cell marker 106, pattern identifier 107, loop identifier 108, and I/O calculator 109. Each of the depicted components is connected to one another over a system bus or over (or is part of) a network, such as, for example, a Local Area Network (“LAN”), a Wide Area Network (“WAN”), and even the Internet. Accordingly, each of the depicted components as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the system bus or network.

Generally, computer architecture 100 can be used to identify loops and their corresponding input data and output data from within a spreadsheet.

Formula parser 101 is configured to receive a spreadsheet, parse the spreadsheet for formulas, and output any formulas within the spreadsheet. Normalizer 102 is configured to receive one or more formulas, normalize the formulas, and output corresponding normalized formulas. Normalizing formulas can include converting formulas to a different reference format. For example, formulas can be converted from a reference format that identifies cells using letters for columns and numbers for rows such as, for example, the A1 format, to a reference format that identifies cells using numbers for both columns and rows such as, for example, the R1C1 format.

For example, a formula with relative references such as “=A1+A2” in cell B3 would be “=R[−2]C[−1]+R[−1]C[−1]” in R1C1 notation. On the other hand, a formula with absolute references such as “=$A$1+$A$2” would be “=R1C1+R2C2” regardless of which cell it was contained in.

Dependency calculator 103 is configured to receive one or more formulas, identify dependencies between the formulas, and output the identified dependencies. Circular reference calculator 104 is configured to receive dependencies, identify circular references in the dependencies, and output the circular references. Cell marker 106 is configured to receive circular references, mark cells with detected circular references as part of an iterative calculation, and output the marked cells.

Pattern identifier is configured to receive one or more normalized formulas marked cells, identify repetitive formulas, and output the identical formulas. Repetitive formulas can be formulas that are otherwise identical except for a row or column offset. Loop identifier 108 is configured to receive repetitive formulas, identify loops within the identical formulas, and output the identified loops. I/O calculator 109 is configured to receive one or more loops and corresponding normalized formulas, identify input data and output data for the loops, and output the identified input data and output data.

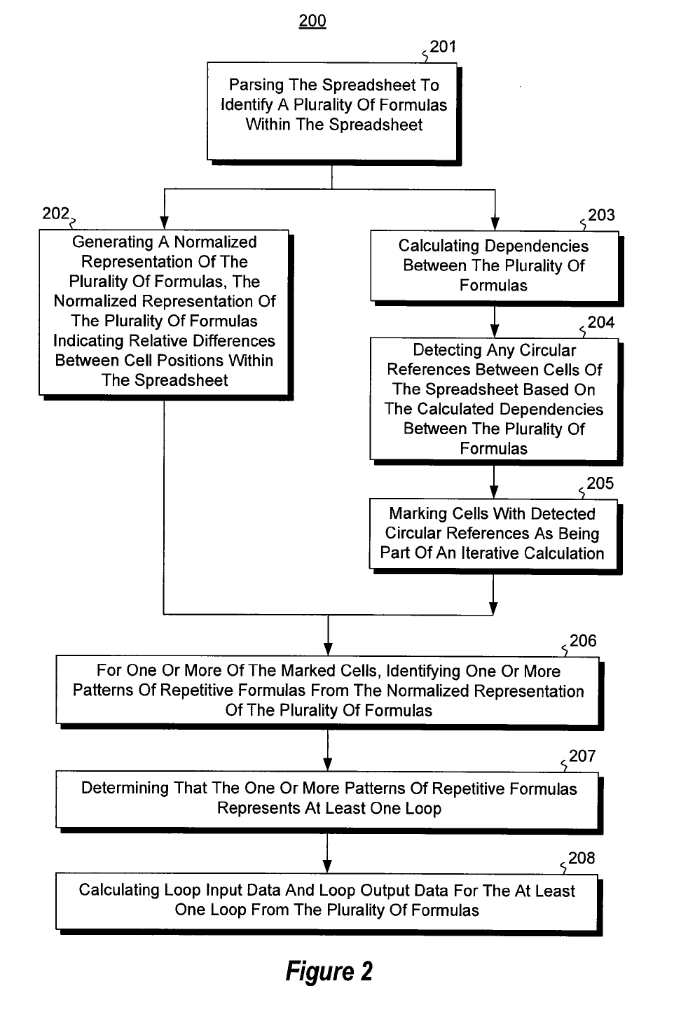

FIG. 2 illustrates a flow chart of an example method 200 for decompiling loops in a spreadsheet. Method 200 will be described with respect to the components and data of computer architecture 100.

Method 200 includes an act of parsing the spreadsheet to identify a plurality of formulas within the spreadsheet (act 201). For example, formula parser 101 can receive spread sheet 111. From spreadsheet 111, formula parser 101 can parse spreadsheet 111 to identify formulas 112, including formulas 112A, 112B, 112C, etc. Formula parser 101 can send formulas 112 to normalizer 102 and dependency calculator 103.

Method 200 includes an act of generating a normalized representation of the plurality of formulas, the normalized representation of the plurality of formulas indicating relative differences between cell positions within the spreadsheet (act 202). For example, normalizer 102 can receive formulas 112 from formula parser 101. From formulas 112, normalizer 102 can normalize formulas 112 in to normalized formulas 112N. Normalizer 102 can output normalized formulas 112N to pattern identifier 107 and I/O calculator 109.

Each normalized formula in normalized formulas 112N can correspond to a formula in formulas 112. For example, normalized formula 112AN corresponds to formula 112A, normalized formula 112BN corresponds to formula 112B, normalized formula 112CN corresponds to formula 112C, etc. In some embodiments, normalizer 102 normalizes formulas by converting formulas from A1 format to R1C1 format. For example, normalizer 102 can receive formulas 112 in A1 format and can convert formulas 112 to formulas 112N in R1C1 format.

Method 200 includes an act of calculating dependencies between the plurality of formulas (act 203). For example, dependency calculator 103 can receive formulas 112 from formula parser 101. From formulas, 112, dependency calculator 102 can calculate dependencies 113 between formulas within formulas 112. Dependency calculator 102 can send dependencies 113 to circulator reference calculator 104. A dependency can include a first formula using a variable value that is generated by a second formula such that any change to the second formula can alter the results of the first formula.

Method 200 includes an act of detecting any circular references between cells of the spreadsheet based on the calculated dependencies between the plurality of formulas (act 204). For example, circular reference calculator 104 can receive dependencies 113. From dependencies 113, circular reference calculator 104 can detect circular references 114 between cells of spreadsheet 111 based on dependencies 113. Circular reference calculator 104 can send circular references to cell marker 106. Circular references between cells can include cells that mutual reference one another. For example, a formula in cell A3 can reference cell B5 and a formula in cell B5 can also reference cell A3.

Method 200 includes an act of an act of marking cells with detected circular references as being part of an iterative calculation (act 205). For example, cell marker 106 can receive circular references 114. From circular references 114, cell marker 106 can mark cells (marked cells 116) corresponding to circular references 114 (of spreadsheet 111) as being part of an iterative calculation. Cell marker can send marked cells 116 to pattern identifier 107. An iterative calculation can include repeatedly performing similar calculations that are potentially a repetitive pattern.

Method 200 includes for one or more of the marked cells, an act of identifying one or more patterns of repetitive formulas from the normalized representation of the plurality of formulas (act 206). For example, pattern identifier 107 can receive marked cells 116 and normalized formulas 112N. From marked cells 116 and normalized formulas 112N, pattern identifier 107 can identify repetitive formulas 117. Repetitive formulas can be formulas that are otherwise identical except for a row or column offset. Pattern identifier 107 can send repetitive formulas 117 to loop identifier 108. Identical (repetitive) formulas can indicate that possibility of a loop within spreadsheet 111.

Method 200 includes an act of determining that the one or more patterns of repetitive formulas represents at least one loop (act 207). For example, loop identifier 108 can receive identical (repetitive) formulas 117. From identical formulas 117, loop identifier 108 can identify loop 108. Loop identifier 108 can send loop 118 to I/O calculator 108. Loop 118 can represent a series of identical iterative calculations based on the dependent data within spreadsheet 111.

Method 200 includes an act of calculating loop input data and loop output data for the at least one loop from the plurality of formulas (act 208). For example, I/O calculator 109 can receive normalized formulas 112N and loop 118. From normalized formulas 112N and loop 118, I/O calculator 109 can calculate input data 121 and output data 122 for loop 118. Input data 121 and output data 122 can be used in the generation of other code (e.g., programming language code, such as, C#, C++, Visual Basic, etc.) for implementing the semantics of loop 118.

Upon identifying a loop and corresponding input data and output data, other modules can represent loop semantics in programming language code. For example, loop 118, input data 121, and output data 122 can be used to represent the semantics of loop 118 in C# code. Further modules can also update a spreadsheet to show loop semantics. For example, spreadsheet 111 can be updated to show the semantics of loop 118.

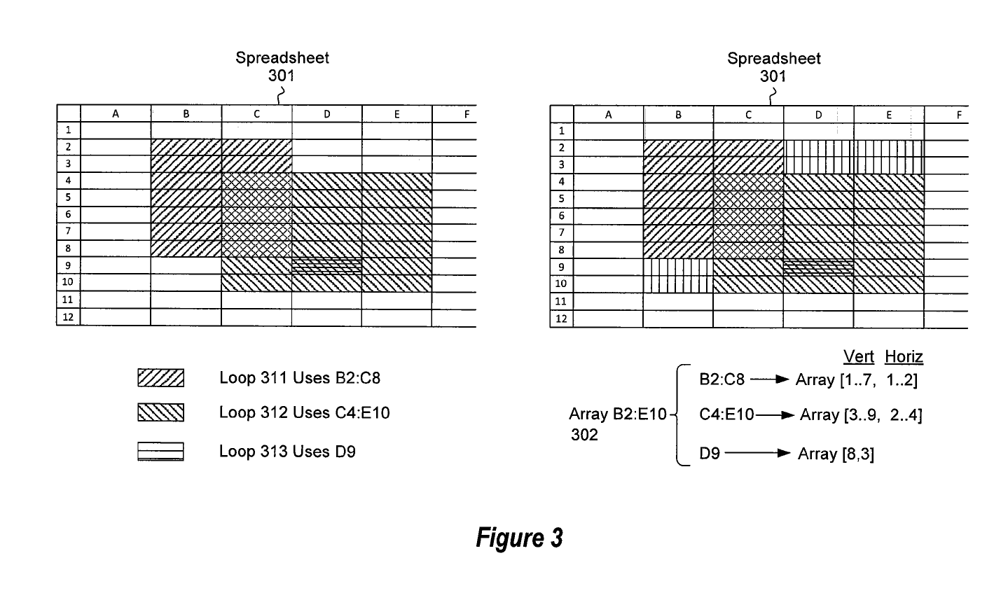

In some embodiments, input and/or output data for a loop is taken for overlapping portions of a spreadsheet. In these embodiments, an array can be used to facilitate more efficient processing of the input and output data. FIG. 3 illustrates an example of representing overlapping portions of a spreadsheet within an array 302.

As depicted, loops 311, 312, and 313 used overlapping ranges of cells within spreadsheet 301. Loop 311 uses B2:C8, loop 312 user C4:E10, and loop 313 using D9. The different types of hatching visually represent how the different ranges overlap within spreadsheet 301. Array 302 can be used to store the range B2:E10. The vertical hatching identifies portions of array 302 that are not used by any of loops 311, 312, and 313.

To reference particular ranges of cells within spreadsheet 301, indexes into array 302 are used. For example, the range B2:C8 is represented by positions 1, 1 through 7, 2 in array 302. Similarly, the range C4:E10 is represented by positions 3, 2 through 9, 4 in array 302. D9 is represented by position 8, 3 in array 302. Accordingly, cells are essentially separated out into their own variables.

The use of arrays can increase efficiency and be used to produce more readable code.

Accordingly, loops and corresponding data can be identified in one or more phases. For example, formulas can be parsed into an R1C1 notation. The graph of all possible dependencies can be walked, starting at the result cell. Possible circularity can be detected and those cells marked as being part of an iterative calculation loop. In some embodiments, the order in which dependencies are walked may is considered. The order can assist in determining what portions of a spreadsheet may be part of the loop and which portions probably are not. This determination can be facilitated by separating absolute from relative references and using cell ranges as hints that a loop might be present.

Loops can then be matched dynamically by observing patterns of identical formulas in the result. For example, matching can compare the formulas in R1C1 notation. Identical (repetitive) formulas that vary in an appropriate dimension (e.g., either rows or columns) can be placed in a loop. Nested loops can similarly be detected.

Input and output data can subsequently be identified by examining collected formulas. From liveness analysis it can be determined what cells are inputs to the loop and what cells are output from the loop. Inputs and outputs can be stored in arrays when appropriate, and indexing expressions utilized. Overlaps between loop iterations and generated loop carry assignments are also addressed as needed.

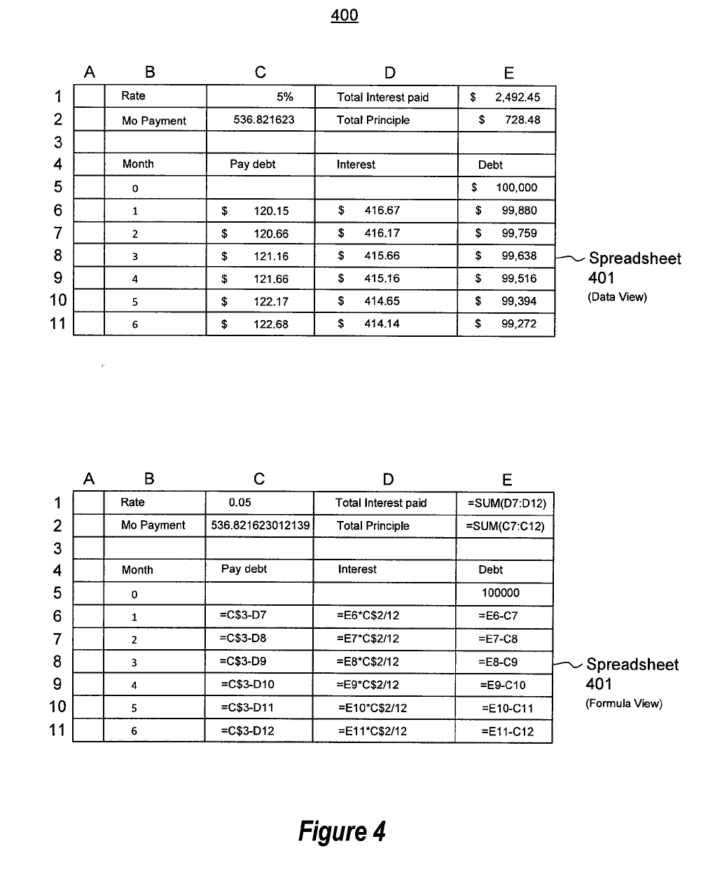

FIG. 4 illustrates a data view and corresponding formula view for a spreadsheet 401. A more detailed example of identifying loop semantics within a spreadsheet is now described with respect to the formula view of spreadsheet 401.

An initial (or naïve) translation of the formulas is:

C2=0.05

C3=536.821623012139

C7=C$3−D7

C8=C$3−D8

C9=C$3−D9

C10=C$3−D10

C11=C$3−D11

C12=C$3−D12

D7=E6*C$2/12

D8=E7*C$2/12

D9=E8*C$2/12

D10=E9*C$2/12

D11=E10*C$2/12

D12=E11*C$2/12

E2=SUM(D7:D12)

E3=E6−E12

E6=100000

E7=E6−C7

E8=E7−C8

E9=E8−C9

E10=E9−C10

E11=E10−C11

E12=E11−C12

After adjusting for calculation order, with E2 selected as the output cell. Formulas with “identical” R1C1 notation are grouped. For example, the R1C1 notations for calculating D7, C7, and E7 are identical to the R1C1 notations for calculating D8, C8, and E8, for calculating D9, C9, and E9, for calculating D10, C10, and E10, and for calculating D11, C11, and E11. The R1C1 notation for D12 is also identical to other values in the D column.

C2=0.05

C3=536.821623012139

E6=100000

D7=E6*C$2/12

C7=C$3−D7

E7=E6−C7

D8=E7*C$2/12

C8=C$3−D8

E8=E7−C8

D9=E8*C$2/12

C9=C$3−D9

E9=E8−C9

D10=E9*C$2/12

C10=C$3−D10

E10=E9−C10

D11=E10*C$2/12

C11=C$3−D11

E11=E10−C11

D12=E11*C$2/12

E2=SUM(D7:D12)

As the formulas are processed, an attempt to match a loop is performed whenever a repetitive formula is detected. So, for example, when D8 is emitted, the entire calculation is examined for possible patterns:

C2=0.05

C3=536.821623012139

E6=100000

D7=E6*C$2/12

C7=C$3−D7

E7=E6−C7

D8=E7*C$2/12

A pattern is not detected yet. However, when D9 is emitted there are now two loop iterations C7, E7, D8 and C8, E8, D9:

C2=0.05

C3=536.821623012139

E6=100000

D7=E6*C$2/12

C7=C$3−D7

E7=E6−C7

D8=E7*C$2/12

C8=C$3−D8

E8=E7−C8

D9=E8*C$2/12

These are repetitive. That is, these are essentially the same calculation but shifted by one cell. So a loop is created for them. The loop adds one to the row offset after the first iteration. This results in:

C2=0.05

C3=536.821623012139

E6=100000

D7=E6*C$2/12

begin loop(row offset=+1,iterations=2)

C7=C$3−D7

E7=E6−C7

D8=E7*C$2/12

end loop

C9=C$3−D9

E9=E8−C9

D10=E9*C$2/12

C10=C$3−D10

E10=E9−C10

D11=E10*C$2/12

C11=C$3−D11

E11=E10−C11

D12=E11*C$2/12

E2=SUM(D7:D12)

Continuing for all of the iterations, the loop results in:

C2=0.05

C3=536.821623012139

E6=100000

D7=E6*C$2/12

begin loop(row offset=+1,iterations=5)

C7=C$3−D7

E7=E6−C7

D8=E7*C$2/12

end loop

E2=SUM(D7:D12)

Matching arrays results in:

C7=ZEROS(5)

D7=ZEROS(6)

E6=ZEROS(6)

C2=0.05

C3=536.821623012139

E6[1]=100000

D7[1]=E6[1]*C$2/12

for i in 1 . . . 5

C7[i]=C3−D7[i]

E6[i+1]=E6[i]−C7[i]

D7[i+1]=E6[i+1]*C2/12

end

E2=SUM(D7)

Further, unnecessary arrays can be eliminated. Data flow detection can be used to realize that some arrays can be demoted to scalars. For example, C7 is never read as an array or accessed outside the loop. As such, C7 can be demoted from an array to just a scalar in the loop body. This also avoids the initial assignment ‘C7=Zeros(5)’. Similar analysis holds for array E6:

D7=ZEROS(6)

C2=0.05

C3=536.821623012139

E6=100000

D7[1]=E6*C2/12

for i in 1 . . . 5

C7=C3−D7[i]

E7=E6−C7

D7[1+i]=E7*C2/12

E6=E7

end

E2=SUM(D7)

Alternately, the formulas could have been matched in a loop this way:

D7=E6*C$2/12

C7=C$3−D7

E7=E6−C7

D8=E7*C$2/12

C8=C$3−D8

E8=E7−C8

Resulting in final code:

D7=ZEROS(6)
C2=0.05
C3=536.821623012139
E6=100000
for i in 1..5

D7[1+i]=E6*C2/12

C7=C3−D7[i]

E7=E6−C7
E6=E7

end
D7[6]=E6*C2/12
E2=SUM(D7)

When a range of cells is within a same column or a same row, such as, for example, D7:D12 or A3:F3 respectively, more appropriate matching can result from matching on the range of cells in the same column or the same row instead of other cells.

Additionally, when further data is in a spreadsheet, a loop can be split with minimal further analysis. For example, consider introducing an error “+1000” into the cell D10. The invention splits up the loop, with no extra analysis needed. Accordingly, embodiments of the invention are robust to formulas that do not match other formulas in the spreadsheet. The resulting code can be:

D7=ZEROS(6)
E6=ZEROS(3)
C3=536.821623012139
E6[1]=100000
C2=5%
D7[1]=E6[1]*C2/12
for i in 1..2 by 1

C7=C3−D7[i]
E6[1+i]=E6[i]−C7
D7[1+i]=E6[1+i]*C2/12

end
C9=C3−D7[3]
E9=E6[3]−C9
D7[4]=E9*C2/12+1000 //Introduced Error
for j in 1..2 by 1

C10=C3−D7[3+j]
E10=E9−C10
D7[4+j]=E10*C2/12
E9=E10

end
E2=SUM(D7)

Constant inputs can matched in a similar way. Given a spreadsheet with the following formulas:

B3=1

B4=3

B5=5

B6=7

B7=9

B8=11

C4=B3+B4

C5=B4+B5

C6=B5+B6

C7=B6+B7

C8=B7+B8

D4=C4*2

D5=C5*2

D6=C6*2

D7=C7*2

D8=C8*2

E4=SUM(D4:D8)

The following code can be produced:

D4=ZEROS(5)
B3=1.. by 2
for i in 1..5

C4=B3[i]+B3[1+i]
D4[i]=C4*2

end
E4=SUM(D4)

Circular dependencies and nested loops can also be handled. For example, for a spreadsheet where each formula is:

B2=IF($A$1,COMPLEX(0,0),IF(IMABS(B2)>=4,COMPLEX(4,0),IMSUM(IMPOWER(B2,2),COMPLEX(B$1,$A2))))

Circular dependencies and loops can be handled over an entire B2:GT202 region, resulting in:

A2=1.. by −0.01
B1=−1.5.. by 0.01

iterative for loop

for i in 1..201

for j in 1..201

if A1

B2[i,j]=COMPLEX(0,0)

else

if IMABS(B2[i,j])>=4

B2[i,j]=COMPLEX(4,0)

else

B2[i,j]=IMSUM(IMPOWER(B2[i,j],2),COMPLEX(B1[j],A2[i]))

end

end

end

end

end

The iterative-for construct captures the semantics of an iterative calculation occurring in the loop. A simpler implementation of the iterative-for construct may be as a for-loop like (“for temp in 1 . . . 100”). Implementations can also have more complex semantics, for example, which mimic a spreadsheet program (e.g., Microsoft® Excel®) calc engine more closely.

The results of the loop analysis can be used in a variety of ways. A spread sheet can be updated and show the loops with additional GUI support. For example, the loop could be colored differently, decorated, or enclosed in a collapsible region. Loop analysis results can be exported to a text file or used in an auditing tool to identify missing potential loops.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. At a computer system including one or more processors and system memory, a method for identifying looping semantics within a spreadsheet, the method comprising:
an act of parsing the spreadsheet to identify a plurality of formulas within the spreadsheet
an act of generating a normalized representation of the plurality of formulas, the normalized representation of the plurality of formulas indicating relative differences between cell positions within the spreadsheet;
an act of calculating dependencies between the plurality of formulas;
an act of detecting any circular references between cells of the spreadsheet based on the calculated dependencies between the plurality of formulas;
an act of marking cells with detected circular references as being part of an iterative calculation;
for one or more of the marked cells, an act of identifying one or more patterns of repetitive formulas from the normalized representation of the plurality of formulas;
an act of determining that the one or more patterns of repetitive formulas represents at least one loop; and
an act of calculating loop input data and loop output data for the at least one loop from the plurality of formulas.

2. The method as recited in claim 1, wherein the act of generating a normalized representation of the plurality of formulas comprises an act of converting the plurality of formulas to R1C1 notation.

3. The method as recited in claim 2, wherein the act of determining that the one or more patterns of repetitive formulas represents at least one loop comprises an act of identifying formulas that are identical expect for one of: a row and a column offset.

4. The method as recited in claim 1, wherein the act of determining that the one or more patterns of repetitive formulas represents at least one loop comprises an act of determining a number of iterations for a loop.

5. The method as recited in claim 1, wherein the act of determining that the one or more patterns of repetitive formulas represents at least one loop comprises an act of identifying a nested loop.

6. The method as recited in claim 1, wherein the act of calculating loop input data and loop output data for the loop comprise:
an act of detecting that data for the loop is to come from a range of cells within the spreadsheet; and
an act of storing the data from the range of cells in an array.

7. The method as recited in claim 6, wherein the act of determining that the one or more patterns of identical formulas represents at least one loop comprises an act of determining that the one or more patterns of repetitive formulas represent a plurality of loops.

8. The method as recited in claim 7, wherein the act of calculating loop input data and loop output data for the at least one loop comprises an act of calculating loop input data and loop output data for the plurality of loops.

9. The method as recited in claim 8, wherein the act of calculating loop input data and loop output data for the plurality of loops comprises:
an act of detecting that data for a first loop is to come from a first range of cells within the spreadsheet; and
an act of detecting that data for a second loop is to come from a second range of cells within the spreadsheet, wherein the first range of cells and the second ranges of cells at least partially overlap.

10. The method as recited in claim 9, further comprising:
an act of creating an array that contains all cells in the first range of cells and all cells in second range of cells.

11. The method as recited in claim 10, further comprising:
an act of determining the minimal area within the array to be covered by the first and second ranges of cells, including:
an act of transforming the first range of cells from within the array into a first array;
an act of storing data from the first range of cells in the first array;
an act of transforming the second range of cells from within the array into a second array; and
an act of storing data from the second range of cells in the second array.

12. A computer program product for use at a computer system, the computer program product of implementing a method for identifying looping semantics within a spreadsheet, the computer program product comprising one or more computer readable media having stored thereon computer-executable instructions that, when executed at a processor, cause the computer system to perform the method, including the following:
parse the spreadsheet to identify a plurality of formulas within the spreadsheet
generate a normalized representation of the plurality of formulas, the normalized representation of the plurality of formulas indicating relative differences between cell positions within the spreadsheet;
calculate dependencies between the plurality of formulas;
detect any circular references between cells of the spreadsheet based on the calculated dependencies between the plurality of formulas;
mark cells with detected circular references as being part of an iterative calculation;
for one or more of the marked cells, identify one or more patterns of repetitive formulas from the normalized representation of the plurality of formulas;
determine that the one or more patterns of repetitive formulas represents at least one loop; and
calculate loop input data and loop output data for the at least one loop from the plurality of formulas.

13. The computer program product as recited in claim 12, wherein computer-executable instructions that, when executed, cause the computer system to generate a normalized representation of the plurality of formulas comprise computer-executable instructions that, when executed, cause the computer system to convert the plurality of formulas to R1C1 notation.

14. The computer program product as recited in claim 13, wherein computer-executable instructions that, when executed, cause the computer system to determine that the one or more patterns of repetitive formulas represents at least one loop comprise computer-executable instructions that, when executed, cause the computer system to identify formulas that are identical expect for one of: a row and a column offset.

15. The computer program product as recited in claim 12, wherein computer-executable instructions that, when executed, cause the computer system to determine that the one or more patterns of repetitive formulas represents at least one loop comprise computer-executable instructions that, when executed, cause the computer system to determining a number of iterations for a loop.

16. The computer program product as recited in claim 12, wherein computer-executable instructions that, when executed, cause the computer system to calculate loop input data and loop output data for the at least one loop comprise computer-executable instructions that, when executed, cause the computer system to calculate loop input data and loop output data for a plurality of loops.

17. The computer program product as recited in claim 16, wherein computer-executable instructions that, when executed, cause the computer system to calculate loop input data and loop output data for the plurality of loops comprise computer-executable instructions that, when executed, cause the computer system to:
detect that data for a first loop is to come from a first range of cells within the spreadsheet; and
detect that data for a second loop is to come from a second range of cells within the spreadsheet, wherein the first range of cells and the second ranges of cells at least partially overlap.

18. The computer program product as recited in claim 17, further comprising computer-executable instructions that, when executed, cause the computer system to create an array that contains all cells in the first range of cells and all cells in second range of cells.

19. The computer program product as recited in claim 18, further comprising computer-executable instructions that, when executed, cause the computer system to:
determine the minimal area within the array to be covered by the first and second ranges of cells, including:
transforming the first range of cells from within the array into a first array;
storing data from the first range of cells in the first array;
transforming the second range of cells from within the array into a second array; and
storing data from the second range of cells in the second array.

20. A computer system, the computer system comprising:
one or more processors;
system memory; and
one or more computer storage media having stored thereon computer-executable instructions representing a formula parser, a normalizer, a dependency calculator, a circular reference calculator, a cell marker, a pattern identifier, a loop identifier, and an I/O calculator, wherein computer-executable instructions are collectively configured to:
parse the spreadsheet to identify a plurality of formulas in A1 format within the spreadsheet
generate a normalized representation of the plurality of formulas in R1C1 format form the plurality of formulas in A1 format, the normalized representation of the plurality of formulas indicating relative differences between cell positions within the spreadsheet;
calculate dependencies between the plurality of formulas;
detect any circular references between cells of the spreadsheet based on the calculated dependencies between the plurality of formulas;
mark cells with detected circular references as being part of an iterative calculation;
for one or more of the marked cells, identify one or more patterns of repetitive formulas from the normalized representation of the plurality of formulas, the repetitive formulas being identical except for differences in one of a row offset and a column offset;
determine that the one or more patterns of repetitive formulas represents at least one loop, including the number of iterations of the at least one loop; and
calculate loop input data and loop output data for the at least one loop from the plurality of formulas from a range of values in an array.
